(19) United States
(12) Patent Application Publication
(10) Pub. No.: US 2024/0100536 A1
(43) Pub. Date: Mar. 28, 2024

(54) HEAD NUT ASSEMBLY AND A GYRATORY CRUSHER APPLYING THE SAME

(71) Applicant: SANDVIK SRP AB, Svedala (SE)

(72) Inventor: Johan GUNNARSSON, Svedala (SE)

(21) Appl. No.: 17/769,079

(22) PCT Filed: Oct. 1, 2020
(86) PCT No.: PCT/EP2020/077532

§ 371 Date: Apr. 14, 2022

(30) Foreign Application Priority Data
Oct. 17, 2019 (EP) 19203800.8

(51) Int. Cl. B02C 2/00

(52) U.S. Cl. CPC B02C 2/005

(57) ABSTRACT

A head nut assembly for securing a mantle on a mainshaft of a gyratory crusher and a gyratory crusher. The head nut assembly includes a cylindrical threaded part and a locking mechanism. The locking mechanism is arranged to engage with the threaded part. The mainshaft has an elongate body and an intermediate portion arranged on the elongate body. A mantle is secured on the mainshaft, the mantle being arranged to form a crushing chamber of the gyratory crusher. The head nut assembly is arranged to secure the mantle on the intermediate portion of the mainshaft.

### FIELD OF INVENTION

The present invention relates to a gyratory crusher having a mantle secured on a mainshaft to form a crushing chamber for crushing materials. And in particular, the invention relates to a head nut assembly for securing the mantle on the mainshaft via a threaded part that engages with a locking mechanism of the head nut assembly.

### BACKGROUND ART

Gyratory crushers are known as a kind of mining machine that break the coarse grains of the minerals and stones. Because of the features of high reduction rate, high yield and uniform mineral particles, the gyratory crushers are widely used in the industries of metallurgy, construction materials, chemical engineering and water and conservancy department.

A gyratory crusher generally has a crusher shaft driven by a motor. The crusher shaft carries a mantle which forms partly a crushing cavity in which the materials are impacted, compressed and warped. The mantle is mounted on the crusher shaft, so that the crusher shaft transfers eccentric movement to the mantle and further to the crushing cavity, and the crushing force on the mantle is further taken by the crusher shaft.

Typically, the mantle is mounted and secured on the crusher shaft by a stop nut threaded on the crusher shaft. When the gyratory crusher is operating, the materials being crushed in the crushing cavity subjects the mantle to a certain rolling action, which creates a tendency for the mantle to move both axially and rotationally on the stop nut and thereby causes stress, concentrated on the threads, between the stop nut and the crusher shaft. This can render the stop nut difficult to turn and can thus render untightening of the stop nut extremely difficult when replacement of the stop nut is required. After a period of operating time, the stop nut will break mainly due to the axial movement of the mantle, displacement of the stop nut will be needed. The external threads of the crusher shaft will be damaged mainly due to the rotational movement of the mantle. Considerable difficulties will be encountered with respect to the repair of such damage, and an extraordinary raise of cost will be occurred if the damage is too serious and replacement of the crusher shaft is required.

Securing mechanisms for mounting a mantle on a crusher shaft of a gyratory crusher, e.g., internally threaded nut, is described in U.S. Pat. Nos. 3,924,815; and 2,787,426.

A gyratory crusher having a stop nut described in U.S. Pat. No. 3,924,815 is so arranged that the stop nut is attached on a vertically split sleeve, the inner surface of which has the shape of a truncated double-cone with a cross section diminishing from the ends. The sleeve is mounted on the crusher shaft and has external threads on which the stop nut is threaded. In case there are damaged screws on the stop nut and the sleeve, removal of the wear parts is performed by cutting them off with a cutting torch. A securing means for a crusher head to a gyratory shaft including internally threaded nut shrink fitted to the main shaft of the crusher is described in U.S. Pat. No. 2,787,426. The securing means includes two nuts, one being shrink fitted to the shaft of the crusher and the other threadedly engages the first nut and engages the head or mantle of the crusher in force transmitting.

None of the above addresses the problem of a stop nut break during crushing operation. Additionally, due to the size and weight of the parts on a gyratory crusher, a securing mechanism with relatively large-sized components will be costly and time-consuming for replacement. It is therefore a need for a gyratory crusher and a head nut assembly thereof that addresses these problems.

### SUMMARY OF THE INVENTION

It is an objective of the present invention to provide a head nut assembly for securing a mantle on a mainshaft of a gyratory crusher that is reliable and preferably has a prolonged service lifetime. It is a further specific objective to provide a gyratory crusher having the head nut assembly mounted on a mainshaft of the crusher and is optimised to protect the mainshaft from wear and damage. The head nut assembly transfers axial and rotational forces between a mantle and the mainshaft and minimises wear of the mainshaft from the axial and rotational forces, to protect the mainshaft from damage and to lengthen its span of life.

The objectives are achieved by providing a locking mechanism to engage with a threaded part of the head nut assembly, so that the threaded part secures an outer head nut and a mantle on a mainshaft of the gyratory crusher. The mantle is fastened on the outer head nut, which are together mounted on the threaded part, the threaded part is further assembled on the mainshaft of the gyratory crusher, and thus the mantle is secured in relation to the mainshaft. Such a configuration significantly increases the reliability of fastening provided by the head nut assembly, and largely reduces the replacement frequency of wear parts: the threaded part and/or the locking mechanism. In particular, the mainshaft of the gyratory crusher is protected by the head nut assembly from abrasive wear, and consequently the service lifetime of the mainshaft is greatly increased.

According to a first aspect of the present invention there is provided a head nut assembly for securing a mantle on a mainshaft of a gyratory crusher, comprising: a cylindrical threaded part; a locking mechanism, characterised in that: the locking mechanism is arranged to engage with the threaded part.

Optionally, the locking mechanism comprises a first locking element arranged to engage with the threaded part to transfer mainly rotational force. Such a configuration is effective to optimise the transmission of rotational force to and from the threaded part, and the design of the first locking element is specifically focused on transferring the rotational force.

Optionally, the first locking element comprises at least one key, wherein the key engages with an internal surface of the threaded part. Using one or more keys to act as the locking mechanism engaging with the threaded part, enables a compact design of the head nut assembly.

Optionally, the key has two opposed side surfaces extended in an axial direction, the side surfaces receive and transfer the rotational force. Optionally, the key further has two opposed outside surfaces extending between the side surfaces, each of the outside surfaces is transverse to both of the side surfaces, and one of the outside surfaces engages with the internal surface of the threaded part. Such a configuration of the key is advantageous to efficiently transfer the rotational force to and from the threaded part.

Optionally, the key is substantially flat in a radial direction, and the outside surfaces are planar surfaces. Such a configuration of a flat key engaging with the threaded part, provides a compact design of the head nut assembly, and further avoids stress concentration between the key and the threaded part on the outside surfaces.

Optionally, the key matches with a corresponding groove arranged on the internal surface of the threaded part. Such a configuration allows the key to engage with the corresponding groove of the threaded part to transfer the rotational force to and from the threaded part.

Optionally, the key matches with a corresponding recess arranged on the mainshaft. Such a configuration allows the key to further engage with the corresponding recess on the mainshaft, such that the keys are aligned with the mainshaft and the threaded part to transfer the rotational force therebetween. Accordingly, by using the keys to secure the threaded part to the mainshaft, is advantageous in protecting the mainshaft from any damages caused by the rotational force. And thus, replacement will be due to damage or wear of the key that no longer secures the threaded part onto the mainshaft.

Optionally, the number of keys is equal to or less than the number of recesses on the mainshaft. Such configuration aligning the number of keys and the number of recesses allows the locking mechanism to be mechanically matched with the mainshaft in a more reliable way, and the configuration of having more recesses than the keys, enables backup recesses to be used in engagement with keys when the used recesses are worn out after a certain time of operation.

Optionally, the locking mechanism further comprises a second locking element arranged to engage with the threaded part to transfer mainly axial force. Such a configuration is effective to optimise the transmission of axial force to and from the threaded part, and the design of the second locking element is specifically focused on transferring the axial force.

Optionally, the second locking element comprises a stop ring, wherein the stop ring engages with an axial end of the threaded part. And optionally, the threaded part further comprises an annular step on the axial end, and the annular step is arranged to receive at least a part of the stop ring. Such a configuration of the stop ring engaging with an axial end and particularly, an annular step of the threaded part, provides a reliable mechanism to secure the threaded part in an axial direction, and as the stop ring receives mainly the axial force instead of the rotational force, a service lifetime of the stop ring is largely increased.

Optionally, the stop ring is arranged to be detachably fastened on the mainshaft, to transfer the axial force between the threaded part and the mainshaft. And optionally, the stop ring is threadedly engaged with the mainshaft. The stop ring is configured to be detachably fastened on the mainshaft, so as to engage with the threaded part to transfer the axial force, or to disengage with the threaded part to release it from the mainshaft in a condition of replacement due to abrasive wear. Advantageously, as the stop ring transfers mainly the axial force between the threaded part and the mainshaft, the threads on the mainshaft, where the stop ring is threaded onto, will not be damaged due to rotational movement of the mantle assembled on the threaded part.

According to a second aspect of the present invention there is provided a gyratory crusher for crushing feed materials comprising: a mainshaft having an elongate body and an intermediate portion arranged on the elongate body; a mantle secured on the mainshaft, the mantle is arranged to form a crushing chamber of the gyratory crusher; and a head nut assembly according to the present invention, the head nut assembly is arranged for securing the mantle on the intermediate portion of the mainshaft.

Optionally, at least one key of the head nut assembly transfers mainly rotational force between a threaded part of the head nut assembly and the mainshaft, to secure the threaded part on the mainshaft in a rotational direction. And optionally, a stop ring of the head nut assembly transfers mainly axial force between the threaded part and the mainshaft to secure the threaded part on the mainshaft in an axial direction. According to the subject invention, the key is configured to mainly transfer rotational force between the threaded part and the mainshaft, and the stop ring is configured to mainly transfer axial force between the threaded part and the mainshaft, such configuration allows the first and second locking elements to be designed specifically on either the rotational force or the axial force, to prolong their service lifetime and further optimize the transmission of the rotational and the axial forces.

Preferably, the threaded part of the head nut assembly is secured on the intermediate portion of the mainshaft, by having the key aligned and engaged with a groove on the threaded part and a recess on the mainshaft. Such a configuration of the key aligned with the groove on the threaded part and the recess on the mainshaft is advantageous for securing the threaded part on the mainshaft in a rotational direction with a compacted locking mechanism.

Optionally, the gyratory crusher further comprises an outer head nut having inner threads, wherein the outer head nut is threaded on the threaded part of the head nut assembly via the inner threads, and the mantle is fastened on the outer head nut, to be further secured on the mainshaft. According to the subject invention, the mantle is installed on the mainshaft via the head nut assembly and the outer head nut, to form the crushing chamber for crushing the feed materials. When in a case of replacement of the head nut assembly due to abrasive wear, the mantle is removed from the outer head nut and the threaded part, to release the outer head nut and/or the head nut assembly for replacement.

### BRIEF DESCRIPTION OF DRAWINGS

A specific implementation of the present invention will now be described, by way of example only, and with reference to the accompanying drawings in which:

FIG. 1 is a cross sectional view of a gyratory crusher according to a specific implementation of the present invention in which a mantle is detachably mounted at a mainshaft via a head nut assembly and an outer head nut;

FIG. 2 is a perspective view of an assembly having the mainshaft and the head nut assembly of FIG. 1;

FIG. 3 is an exploded view of the assembly of FIG. 2 according to one specific implementation of the present invention;

FIG. 4 is a cross sectional side view of the assembly of FIG. 2;

FIG. 5 is a perspective view of the threaded part according to one specific implementation of the present invention;

FIG. 6 is a perspective view of the threaded part according to another specific implementation of the present invention;

FIG. 7 is a perspective view of the threaded part according to yet another specific implementation of the present invention;

FIG. 8 is a perspective view of the intermediate portion of the mainshaft according to another specific implementation of the present invention.

### DETAILED DESCRIPTION OF PREFERRED EMBODIMENT OF THE INVENTION

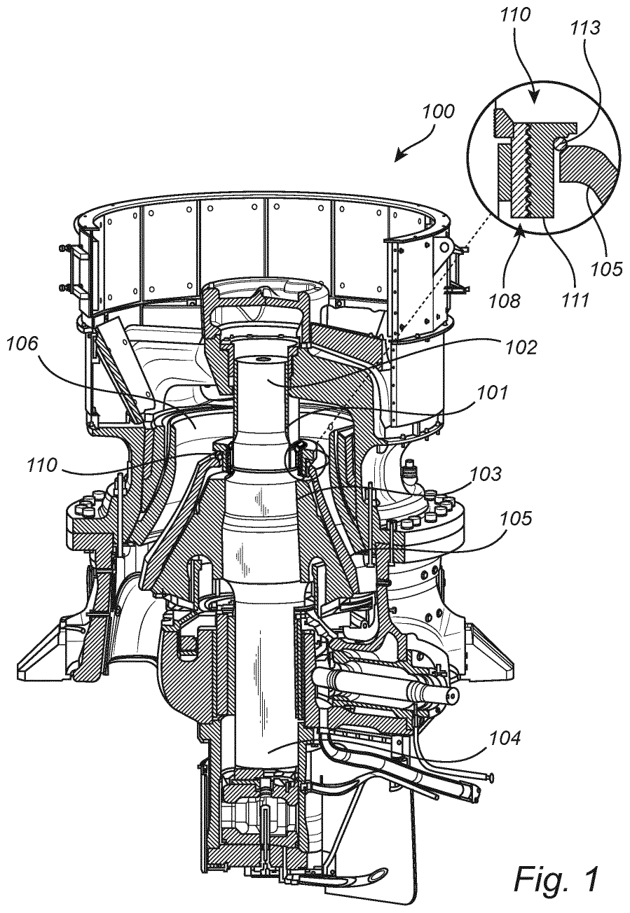

FIG. 1 is a cross sectional view of a gyratory crusher 100 according to a specific implementation of the present invention in which a mantle 105 is detachably mounted at a mainshaft 101 via a head nut assembly 108 and an outer head nut 111. The mainshaft 101 has an elongate body 102, 104 and an intermediate portion 103 arranged between the elongate body 102, 104. The mantle 105 is secured on the mainshaft 101 and arranged to form part of a crushing chamber 106 of the gyratory crusher 100 where feed materials are imported to be impacted, compressed and warped. Please refer to the enlarged view of 110, representing the head nut assembly 108 and the outer head nut 111 having inner threads. The outer head nut 111 is threaded on the head nut assembly 108 via the inner threads, and the mantle 105 is fastened on the outer head nut 111, so that the mantle 105 is further secured on the mainshaft 101. In one embodiment of the present invention, the mantle 105 is fastened on the outer head nut 111 via a ring-shaped element 113, e.g., a torch ring or burning ring 113, where the ring-shaped element 113 is welded to both the mantle 105 and the outer head nut 111. Please refer to FIG. 1 again, the head nut assembly 108 is arranged for securing the mantle 105 on the intermediate portion 103 of the mainshaft 101. During operation, the mainshaft 101 is driven by a motor and transfers movement to the mantle 105 via the head nut assembly 108 and the outer head nut 111, so that the movement of the mantle causes the crushing of materials inside the crushing chamber 106. On the other side, the crushing forces of the materials received by the mantle 105 is transferred to the mainshaft 101 via the head nut assembly 108 and the outer head nut 111. After a certain period of operation, the outer head nut 111 and/or the head nut assembly 108 will be worn out by the forces between the mantle 105 and the mainshaft 101, and displacement of the outer head nut 111 and/or the head nut assembly 108 is needed. Advantageously, the mainshaft 101, particularly the intermediate portion 103 of the mainshaft 101 is protected by the head nut assembly 108 from wearing.

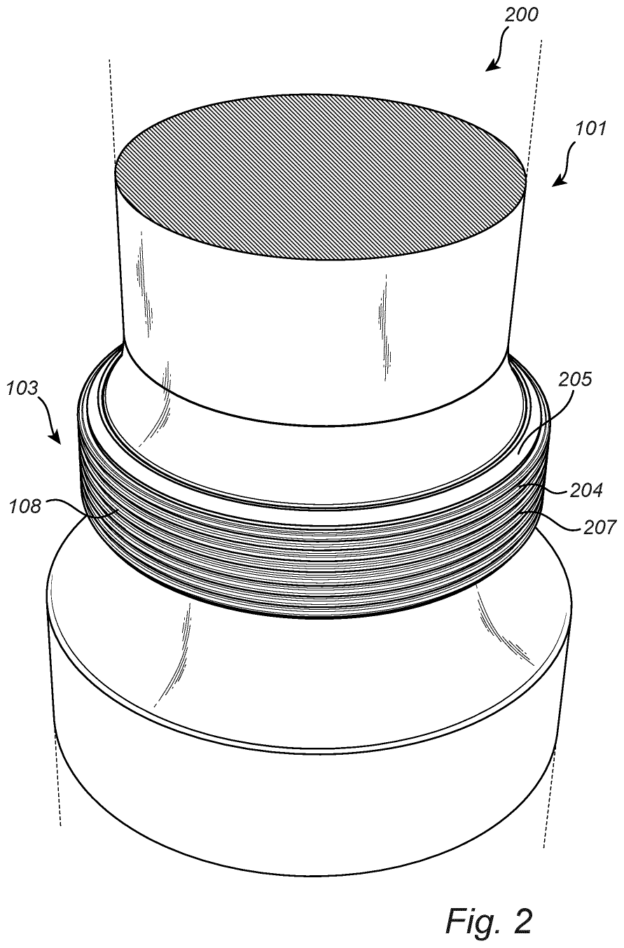

FIG. 2 is a perspective view of an assembly 200 having the mainshaft 101 and the head nut assembly 108 of FIG. 1. The head nut assembly 108 is mounted on the intermediate portion 103 of the mainshaft 101 and includes cylindrical threaded part 204 and a locking mechanism 205 that engages with the threaded part 204. The threaded part 204 has external threads 207 where the outer head nut 111 is threaded on so as to secure the mantle 105 on the mainshaft 101.

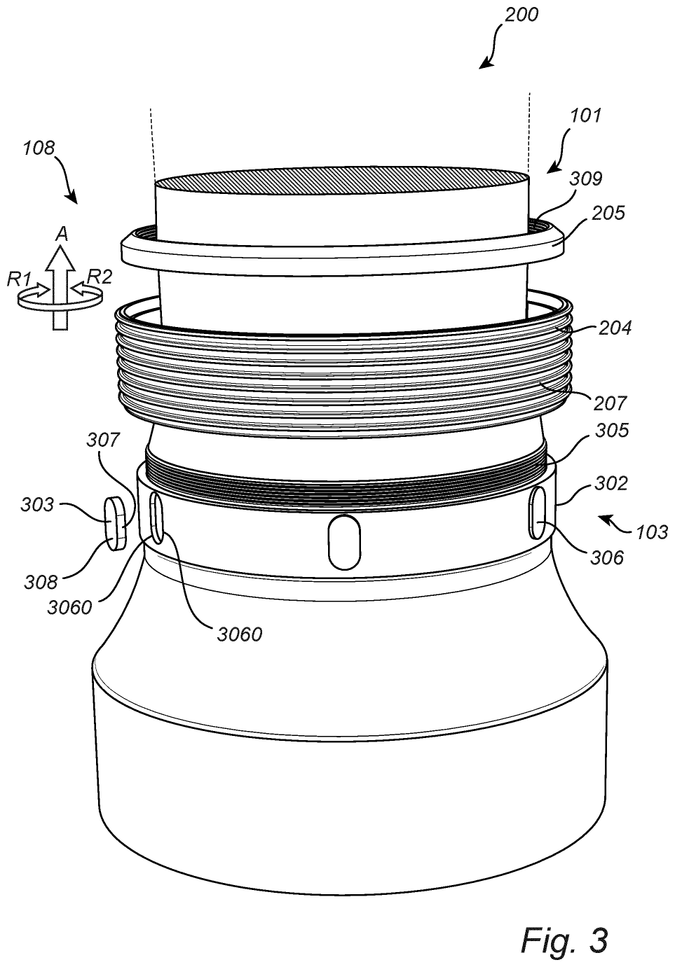

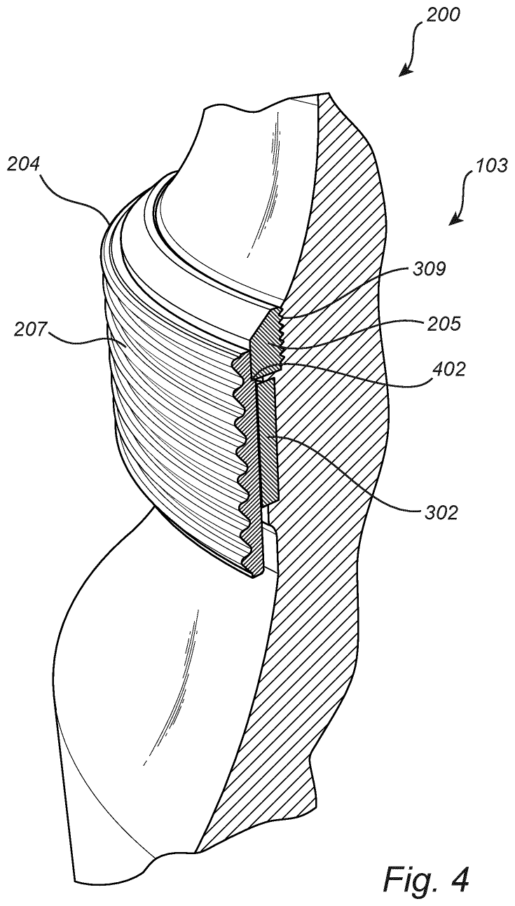

FIG. 3 is an exploded view of the assembly 200 of FIG. 2 according to one specific implementation of the present invention. FIG. 4 is a cross sectional side view of the assembly 200 of FIG. 2.

Please refer to FIGS. 3 and 4 together. The assembly 200 includes a mainshaft 101 and a head nut assembly 108. The intermediate portion 103 of the mainshaft 101 includes a first part 305 and a second part 302. The first part 305 is threaded, and the second part 302 is where the threaded part 204 is secured by the locking mechanism 205, 303. In the FIG. 3 embodiment, the second part 302 of the intermediate portion 103 includes at least one recesses 306 that receives the locking mechanism of the head nut assembly 108. In one embodiment, the locking mechanism 205, 303 includes a first locking element 303 that engages with the threaded part 204 to transfer mainly rotational force. In a preferred embodiment, the locking mechanism 205, 303 further includes a second locking element 205 that engages with the threaded part 204 to transfer mainly axial force. Advantageously, the first locking element 303 of the head nut assembly 108 transfers mainly rotational force between the threaded part 204 and the mainshaft 101, to secure the threaded part 204 on the mainshaft 101 in a rotational direction R1, R2, and the second locking element 205 of the head nut assembly 108 transfers mainly axial force between the threaded part 204 and the mainshaft 101, to secure the threaded part 204 on the mainshaft 101 in an axial direction A. Moreover, the first and second locking elements 303, 205 each takes either rotational force or axial force, and thus, designing of the first and second locking elements 303, 205 is more specific and the respective mechanism is thus able to endure forces of higher strength.

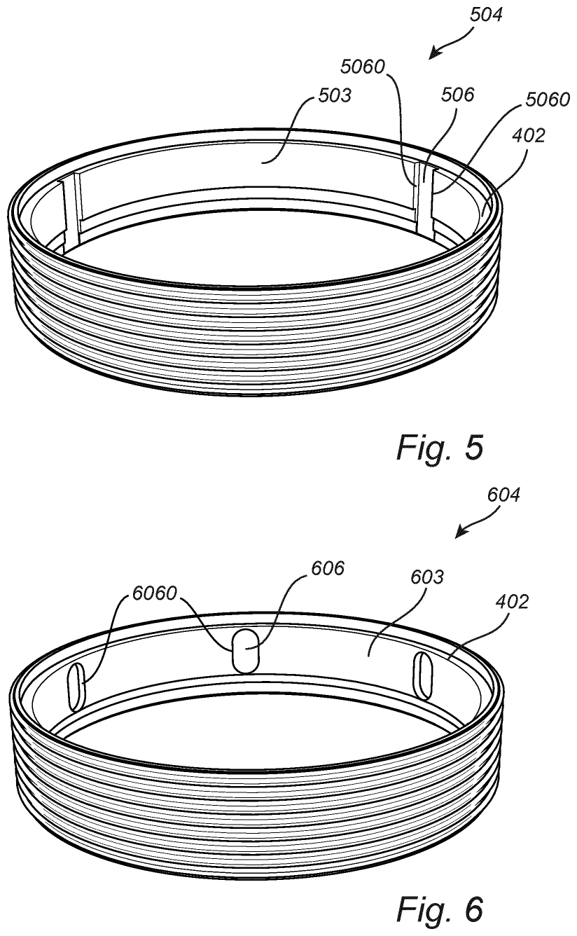

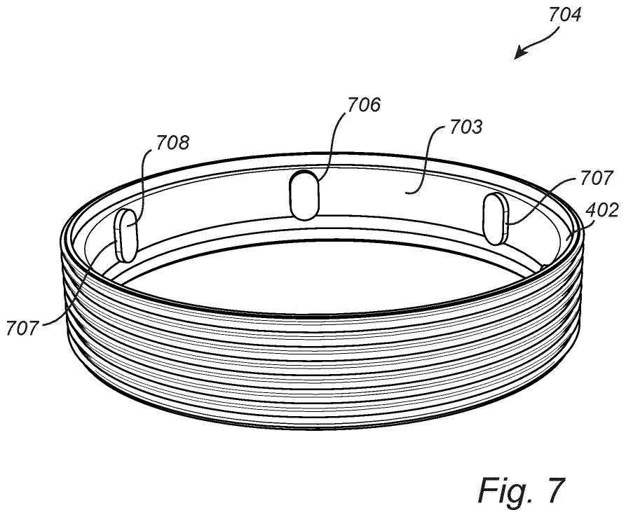

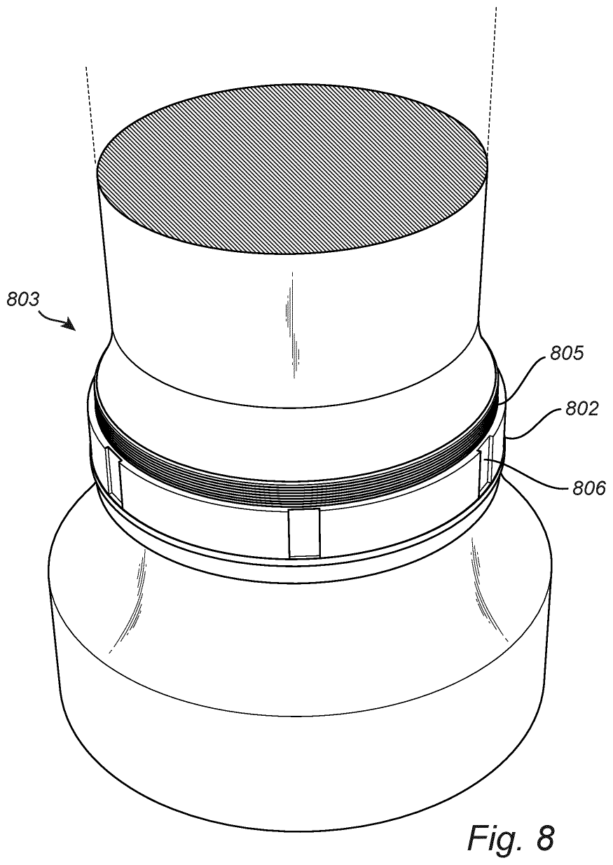

In a preferred embodiment of the present invention, the first locking element 303 includes at least one key 303. In the mechanical field, the term “key” is widely used to refer to a locating and/or locking mechanism, that locates and/or locks a first component to a second component. In the present invention, “key” is used throughout the text to refer to a mechanical part that enables a threaded part to be rotationally locked on a mainshaft. By way of example, the mechanical part can be a relatively small metal plate with a certain thickness, similar to a coin or more specific an oval shaped coin. The mechanical part is placed between the threaded part and the mainshaft to prevent displacement of the threaded part from the mainshaft. In particular, the key 303 engages with an internal surface of the threaded part 204. In one specific embodiment of the present invention, the key 303 engages with a groove (as shown in FIGS. 5 and 6) on the internal surface of the threaded part 204, and in another specific embodiment, the key 303 is machined on the internal surface (as shown in FIG. 7). Preferably, the key 303 further matches with the corresponding recess 306 arranged on the mainshaft 101. Accordingly, the threaded part 204 of the head nut assembly 108 is secured on the intermediate portion 103 of the mainshaft 101, by having at least one key 303 aligned and engaged with the groove on the threaded part 204 and the recess 306 on the mainshaft 101.

Referring to FIG. 3, the key 303 is substantially flat in a radial direction, having two opposed side surfaces 307 extended in the axial direction A, where the side surfaces 307 each contacts with an inner side surface 3060 of the recess 306 and inner side surfaces 5060, 6060 of grooves 506, 606 of threaded parts 504, 604 (as shown in FIGS. 5-6), to receive and transfer the rotational force to and from the threaded part. Optionally, the key 303 has two opposed flat surfaces 308 extended in the axial direction A. The flat surfaces 308 are transverse to the side surfaces 307, and one of the flat surfaces 308 engages with the internal surface of the threaded part 204, while the other one of the flat surfaces 308 engages with the recess 306 of the mainshaft 101, when the key 303 and the threaded part 204 are assembled on the mainshaft 101. In the embodiment of FIG. 3, the cross section of the key 303 is substantially oval; however, the shape of the key 303 shall not be considered to be a limitation to the present invention, in another embodiment of the present invention, the key 303 may have other shapes, e.g., the cross section of the key may be square, rectangle, or polygon, as long as it provides the two aforementioned side surfaces 307 that match and engage with the side surfaces of the corresponding recess to transfer the rotational forces to and from the mainshaft. In a preferred embodiment, the side surfaces 307 provided by the key 303 are vertical and substantially parallel to the axial direction A, to only transfer the rotational forces perpendicular to the axial direction A; however, it shall not be considered a limitation of the present invention, and in another embodiment, the side surfaces 307 provided by the key 303 may be transverse to the axial direction A, and the transverse side surfaces mainly transfer the rotational forces perpendicular to the axial direction A.

In another embodiment of the present invention, the key does not need to be flat in the radial or any other direction. To be specific, the key has two opposed side surfaces extended in the axial direction A, where the side surfaces are substantially flat and each surface contacts with an inner side surface of a corresponding recess on the mainshaft and/or further contacts with an inner side surface of a corresponding grooves on the threaded part, to receive and transfer the rotational force to and from the threaded part. More specifically, the key has a protruded portion, e.g., pointed portion, arranged to be engaged with the corresponding groove or the corresponding recess. The protruded portion of the key extends in a radial direction between the side surfaces of the key, and the corresponding groove/recess is dented to match and receive the protruded portion of the key. In this way, the surface of the key extended between and transverse to the side surfaces is not a planar surface. Optionally, the key has two opposed protrusions that protrude in the radial direction inwardly and outwardly, and the corresponding groove and recess respectively matches to and receives one of the two opposed protrusions, when the key and the threaded part are assembled on the mainshaft. Preferably, the side surfaces of the key in this embodiment are vertical and substantially parallel to the axial direction A, to only transfer the rotational forces perpendicular to the axial direction A; however, it shall not be considered a limitation of the present invention, and the side surfaces may be transvers to the axial direction A and is arranged to mainly transfer the rotational forces perpendicular to the axial direction A.

In a preferred embodiment of the present invention, the head nut assembly 108 includes one to three keys 303 evenly distributed between the threaded part and the mainshaft, the keys are either separated from the threaded part 204 or machined on the internal surface of the threaded part 204. In another embodiment, the number of keys may be more than three, e.g., five keys, six keys etc., and the keys may be randomly arranged between the threaded part and the mainshaft in correspondence to the grooves/recesses thereon. The number of recesses 306 arranged on the mainshaft 101 is preferably to be equal to or greater than the number of keys 303. In one embodiment, the number of recesses 306 is greater than the number of keys 303 so that the backup recesses 306 will be used to hold the keys 303 after the used recess having had a key fit in has worn out after a certain period of operation on the crusher 100.

By way of example, in one embodiment of FIG. 3, six recesses 306 are arranged, e.g., machined on the mainshaft 101, and one to three keys 303 are engaged with either one to three recesses of the six recesses 306, that is, at least three other recesses 306 are considered back up recesses 306. In operation, the recesses 306 engaged with the keys 303 are receiving and/or transferring the rotational forces, and thus after a certain period of operation, those recesses 306 are worn out, and so are the keys 303 and the external threads of the threaded part may be worn out. In case of replacement, a new head nut assembly with one to three new keys are reassembled on the mainshaft aligning with the unused back up recesses 306. Advantageously, the service lifetime of the mainshaft 101 is further prolonged.

Please refer to FIGS. 3 and 4, the second locking element 205 comprises a stop ring 205 that engages with an axial end of the threaded part 204. Optionally, the threaded part 204 further includes an annular step 402 on the axial end to receive at least a part of the stop ring 205. The engagement between the stop ring 205 and the annular step 402 of the threaded part 204, secures the threaded part 204 on the mainshaft 101 in the axial direction A. In one embodiment, the stop ring 205 is arranged to be detachably fastened on the mainshaft 101, to transfer the axial force between the threaded part 204 and the mainshaft 101. Specifically, the stop ring 205 has an internal thread 309 that is threaded down on the threads of the first part 305 in the intermediate portion 103 of the mainshaft 101.

In general, when assembling, the threaded part 204 is either heated to expand, or slide down on the mainshaft 101 without expanding. The threaded part 204 further matches on the mainshaft 101 when the key 303 aligns with the recess 306 of the mainshaft, and in the embodiment that the key 303 is separate from the threaded part 204, the key 303 further aligns with the groove on the internal surface of the threaded part 204. The stop ring 205 is further set on the mainshaft 101 to be threadedly engaged with the threads thereon, until it locates on the annular step 402 of the threaded part 204. In different embodiments of the present invention, the assembling of the head nut assembly 108 on the mainshaft 101 may be varied a bit. When assembled, the head nut assembly 108 is advantageously secured on the mainshaft 101 both in the rotational directions R1 and R2, and the axial direction A. Since the stop ring 205 transfers substantially the axial force, it will not suffer much rotational forces that would break it apart, or damage the threads on the mainshaft 101, and as the key 303 of the head nut assembly 108 engages with the recess 306 of the mainshaft, and transfers substantially the rotational force, the head nut assembly 108 is reliably secured in both rotational directions and axial direction, until the assembly 108 is worn out to be replaced with a new one.

FIG. 5-7 are perspective views of threaded parts 504, 604, 704 according to specific implementations of the present invention. In one embodiment, the threaded part 504 has an internal surface 503, the annular step 402, and a groove 506. The groove 506 is an open groove so that an expansion of the threaded part 504 would not be required for it to slide down directly on the mainshaft 101 having the groove 506 aligned with the key 303 fitted in the recess of the mainshaft 101. In another embodiment, the threaded part 604 has an internal surface 603, the annular step 402, and a groove 606. The groove 606 is a closed groove such that the threaded part 604 needs to be heated to expand to set on the mainshaft while aligning the closed groove 606 with a corresponding key 303 positioned in the recess of the mainshaft 101. In yet another embodiment, the threaded part 704 has an internal surface 703, the annular step 402, and at least one machined-on keys 706. The machined-on key 706 has two opposed side surfaces 707 extended in the axial direction A, that would engage with the side surfaces of corresponding recess on the mainshaft. The key 706 further has two opposed flat surfaces 708 extended in the axial direction A that are transverse with the side surfaces 707, one of the flat surfaces 708 is e.g., welded on the internal surface of the threaded part 704, and the other flat surface 708 would engage with a corresponding recess on the mainshaft. The machined-on keys 706 are further aligned and engaged with corresponding recesses on the mainshaft when assembling the threaded part 704 onto the mainshaft 101. During assembling, the threaded part 704 is either heated to expand to match a corresponding closed recess on the intermediate portion of the mainshaft, or the threaded part 704 slides down on an open recess on the mainshaft.

In the description of the present invention, the mentioned “open groove/recess” is defined as a groove/recess that has at least one exit/opening along the border of the groove/recess, which exit/opening would allow the key to slide into the groove/recess, so that the key is secured in the groove/recess. While the mentioned “closed groove/recess” is defined as a groove/recess that has no exit/opening along the border of the groove/recess, to allow the key to slide along, and that the groove/recess has a substantially complete boundary.

FIG. 8 is a perspective view of the intermediate portion 803 of the mainshaft according to another specific implementation of the present invention. The intermediate portion 803 has a first part 805 with threads, and a second part 802 with at least one recesses 806. Optionally, the recess 806 is an open recess that defines a track for the key to slide in. In one embodiment, the threaded part 704 in FIG. 7 with a machined-on key 706 may slide down onto the mainshaft, in a track defined by the recess 806. By way of example, in one embodiment of FIG. 8, there are arranged six open recesses 806 on the mainshaft, and there are arranged one to three keys arranged in the head nut assembly, e.g., one to three machined-on keys arranged on the threaded part 704. In case of replacement, given that the threaded part, the keys and the recesses engaged with the keys may have worn out, a new head nut assembly with one to three keys are reassembled on the mainshaft aligning with the unused recesses.

1. A head nut assembly for securing a mantle on a mainshaft of a gyratory crusher, the head nut assembly comprising:
a cylindrical threaded part; and
a locking mechanism, wherein the locking mechanism is arranged to engage with the threaded part.

2. The head nut assembly as claimed in claim 1, wherein the locking mechanism includes a first locking element arranged to engage with the threaded part to transfer mainly rotational force.

3. The head nut assembly as claimed in claim 2, wherein the first locking element includes at least one key (303, 706), wherein the key engages with an internal surface of the threaded part.

4. The head nut assembly as claimed in claim 3, wherein the key has two opposed side surfaces extending in an axial direction, the side surfaces being arranged to receive and transfer the rotational force.

5. The head nut assembly as claimed in claim 4, wherein the key further has two opposed outside surfaces extending between the side surfaces, wherein each of the outside surfaces is transverse to both of the side surfaces, and wherein one of the outside surfaces engages with the internal surface of the threaded part.

6. The head nut assembly as claimed in claim 5, wherein the key is substantially flat in a radial direction, and the outside surfaces are planar surfaces.

7. The head nut assembly as claimed in claim 3, wherein the key matches with a corresponding groove arranged on the internal surface of the threaded part.

8. The head nut assembly as claimed in claim 3, wherein the key matches with a corresponding recess arranged on the mainshaft.

9. The head nut assembly as claimed in claim 8, wherein the number of keys is equal to or less than the number of recesses on the mainshaft.

10. The head nut assembly as claimed in claim 1, wherein the locking mechanism includes a second locking element arranged to engage with the threaded part to transfer mainly axial force.

11. The head nut assembly as claimed in claim 10, wherein the second locking element includes a stop ring, wherein the stop ring engages with an axial end of the threaded part.

12. The head nut assembly as claimed in claim 11, wherein the threaded part includes an annular step on the axial end, and wherein the annular step is arranged to receive at least a part of the stop ring.

13. The head nut assembly as claimed in claim 11, wherein the stop ring is arranged to be detachably fastened on the mainshaft to transfer the axial force between the threaded part and the mainshaft.

14. The head nut assembly as claimed in claim 11, wherein the stop ring is threadedly engaged with the mainshaft.

15. A gyratory crusher for crushing feed materials, comprising:
a mainshaft having an elongate body and an intermediate portion arranged on the elongate body;
a mantle secured on the mainshaft, the mantle being arranged to form a crushing chamber of the gyratory crusher; and
a head nut assembly according to claim 1 arranged for securing the mantle on the intermediate portion of the mainshaft.

16. The crusher as claimed in claim 15, wherein at least one key of the head nut assembly transfers mainly rotational force between a threaded part of the head nut assembly and the mainshaft, to secure the threaded part on the mainshaft in a rotational direction.

17. The crusher as claimed in claim 15, wherein a stop ring of the head nut assembly transfers mainly axial force between the threaded part and the mainshaft to secure the threaded part on the mainshaft in an axial direction.

18. The crusher as claimed in claim 15, wherein the threaded part of the head nut assembly is secured on the intermediate portion of the mainshaft, by having the key aligned and engaged with a groove on the threaded part and a recess on the mainshaft.

19. The crusher as claimed in claim 15, wherein the gyratory crusher further comprises an outer head nut having inner threads, wherein the outer head nut is threaded on the threaded part of the head nut assembly via the inner threads, and the mantle is fastened on the outer head nut, to be further secured on the mainshaft.
